(19) United States
(12) Patent Application Publication
(10) Pub. No.: US 2021/0031704 A1
(43) Pub. Date: Feb. 4, 2021

(54) GLAZING FOR A VEHICLE COMPRISING A PLATE WITH CATCHES FOR FIXING AN ACCESSORY, AND PLATE

(71) Applicant: SAINT-GOBAIN GLASS FRANCE, COURBEVOIE (FR)

(72) Inventor: Laurent LAMOUREUX, RIBECOURT-DRESLINCOURT (FR)

(21) Appl. No.: 16/766,987

(22) PCT Filed: Nov. 26, 2018
(86) PCT No.: PCT/FR2018/052980

§ 371 Date: May 26, 2020

(30) Foreign Application Priority Data
Nov. 30, 2017 (FR) 1761395

(51) Int. Cl. B60R 11/04; B60J 1/02

(52) U.S. Cl. CPC B60R 11/04; B60R 2011/0071; B60J 1/02

(57) ABSTRACT

A glazing for a vehicle includes a glass pane and a plate for reversibly attaching an optoelectronic accessory, the plate includes, in the lower part, a lower inner catch receiving a lower projecting cylindrical part linked to the accessory, and, in the upper part, an upper inner catch receiving an upper projecting cylindrical part linked to the accessory, the inner catches being oriented in the same direction and oriented toward the top of the plate and the plate further including a bracket extending inwardly substantially at a right angle from the inner face of the plate and pressing, in a direction substantially parallel to the inner face of the plate, and downwardly, one of the projecting cylindrical parts against the adjacent inner catch.

The present invention relates to fixing accessories to glazing of vehicles and, more specifically, to glazing of motor vehicles.

A plate is usually fixed against the inner face of a glass pane of a glazing of a vehicle, in order to allow mechanical attachment of one (or more) accessories to this inner face by means of the plate.

The accessories can be, for example, a rain and/or a luminosity sensor, or even a detector or a camera or a display screen.

The present invention more specifically relates to a glazing for a vehicle comprising a glass pane and at least one plate for reversibly attaching at least one optoelectronic accessory to said glass pane, said plate having a hole facing said accessory, an outer face that is fixed facing an inner face of said glass pane and an inner face oriented on an opposite side regarding said outer face, said inner face comprising means for reversibly attaching said accessory.

Precisely positioning and fixing the accessory to the plate facing the hole is very important.

The prior art known from European patent application number EP 2328782 discloses such a glazing comprising a glass pane and a plate for reversibly attaching an optoelectronic accessory to the plate and thus to the glass pane. This plate thus has a receptacle for receiving this accessory that comprises means for reversibly attaching this accessory.

When the plate is considered vertically, at the top of a glazing, the means for reversibly attaching the accessory in the upper part are formed by two upper lateral stops, one of which is located to the left and the other one of which is located to the right of the receptacle and both of which are oriented toward the bottom of the plate. In the lower part, the means for reversibly attaching the accessory are formed by two lower grooves that are linked together and are oriented upward. These means for reversibly attaching the accessory further comprise an inwardly folded leaf spring that exerts an inward force on the accessory. This leaf spring is not exactly located in the central part of the receptacle since the central part of the receptacle is necessarily located in the vicinity of the hole of the plate; the force exerted by this leaf spring therefore is not central and this makes it difficult to position the accessory in its receptacle.

The plate described in said document allows the accessory to be attached in a reversible manner.

However, this plate is difficult to manufacture and consequently it is expensive since the inwardly folded leaf spring needs to be provided, which is made of a different material from that of the plate. Furthermore, the plate preferably comprises other folded leaf springs, particularly in the upper part, which makes manufacturing even more difficult and further increases the cost. This plate is difficult to implement since the force exerted by the leaf spring is not central, whereas the accessory, for its part, must be centered in its receptacle with a high level of precision.

Furthermore, the upper lateral stops and the components for fastening the one or more folded leaf springs require the provision of many large cut-outs in the thickness of the plate to allow the plate to be manufactured by molding and to allow it to be removed from the mold, which further decreases the effective surface area of the outer face of the plate.

The prior art that is also known from patent application DE 11 2013 006807 discloses a glazing comprising a plate comprising means for reversibly attaching an accessory that are located against the edging of this plate. The plate comprises, on the one hand, in the lower part, two lower inner catches respectively receiving a lower projecting cylindrical part, each linked to the accessory, and, on the other hand, in the upper part, two upper inner catches respectively receiving an upper projecting cylindrical part, each linked to the accessory.

The reversible attachment achieved with these four catches is not precise enough. There is a significant gap, of several tens of millimeters, between the accessory and the plate.

The prior art that is also known from patent application DE 10 2013 005801 discloses a glazing of the type described in the preamble of the present document, the plate of which comprises, on the one hand, in the lower part, a dual lower inner catch receiving a lower projecting cylindrical part that is linked to the accessory, and, on the other hand, in the upper part, two dual upper inner catches, respectively receiving an upper projecting cylindrical part, which are each linked to the accessory.

These dual catches are unsatisfactory since a significant amount of force needs to be exerted in order to introduce a cylindrical part between them, but this force must not be excessive in order to avoid any risk of damaging them. Therefore, there is a significant risk of damaging at least one catch, and even both catches, when the cylindrical part passes between the respective heads thereof in order to attach the accessory. Furthermore, there is a significant risk of damaging at least one catch, and even both catches, when the cylindrical part passes between the respective heads thereof to detach the accessory.

The reversible attachment achieved with these three dual catches is not precise enough.

The present invention intends to overcome the disadvantages of the prior art by proposing a plate that is simpler to manufacture and consequently is less expensive.

The present invention also intends to propose a plate that is simpler to implement, with a system for self-centering the accessory in its receptacle, which system retains the accessory in its receptacle in a self-centered manner. Furthermore, this retention is extremely reliable over time, whilst allowing the accessory to be removed several times so that it can be checked or changed, without degrading the retention function.

The present invention thus intends to propose a solution that allows reversible attachment of the accessory to the plate that is extremely precise in the three spatial dimensions of the vehicle. This precision is increasingly important since the accessories themselves are more precise and are used to capture increasingly precise information.

The present invention also intends to propose a solution that allows the plate to be manufactured by molding without needing to make provision for an element in addition to the plate as molded, and particularly without needing to provide a folded leaf spring made from a different material from that of the plate.

The present invention also intends to propose a solution that allows the plate to be manufactured by molding and allows it to be removed from the mold, while decreasing the amount and the surface area of any cut-outs. Thus, the effective surface area of the outer face of the plate between the accessory and the glass pane is greater and its contact surface with the adhesion means, which allow irreversible attachment of the plate to the inner face of the glass pane, is greater, and the adhesion of the plate to the glass pane is thus improved.

The present invention is thus based on a solution using a plurality of inner catches (at least one in the upper part of the plate and at least one in the lower part of the plate), all of which are oriented in the same direction, and preferably upward, as well as at least one spring bracket in the vicinity of one of these inner catches in order to press part of the accessory against the adjacent inner catch in a direction that is substantially parallel to the inner face of said glass pane, preferably downwardly.

Therefore, this involves ensuring that the accessory is retained in position in its receptacle by rigidly retaining it inwardly and by permanently applying a force thereto that is transverse to the inner-outer direction, i.e. mainly vertically, and preferably downwardly in order to further benefit from the effect of gravity. Permanently applying a force means that the force is present throughout the entire period of fixing the accessory to the plate.

The present invention thus relates to a glazing for a vehicle as claimed in claim 1. This glazing comprises a glass pane and at least one plate for reversibly attaching at least one optoelectronic accessory to said glass pane, said plate having a hole facing said accessory, an outer face fixed facing an inner face of said glass pane and an inner face oriented on an opposite side regarding said outer face, said inner face comprising means for reversibly attaching said accessory.

This glazing is characterized in that said plate comprises:
on the one hand, in the lower part, at least one, and preferably at least two, lower inner catch(es) respectively receiving a lower projecting cylindrical part, which is linked to said accessory; and
on the other hand, in the upper part, at least one, and preferably at least two, upper inner catch(es) respectively receiving an upper projecting cylindrical part, which is linked to said accessory,

said inner catches being oriented in the same direction and being preferably oriented toward the top of said plate; and

said plate further comprising at least one, and preferably two, bracket(s) extending inwardly substantially at a right angle from the inner face of said plate and pressing, in a direction substantially parallel to the inner face of said plate, and preferably downwardly, one of said projecting cylindrical parts against the adjacent inner catch.

When there are two or more brackets, each bracket preferably presses, in a direction substantially parallel to the inner face of said plate, and preferably downwardly, a projecting cylindrical part against the adjacent inner catch.

Consequently, the pressure exerted in a direction substantially parallel to the inner face of said plate is substantially parallel to the inner face of said glass pane. This pressure exertion is permanent.

A catch generally adopts the profile of a hammer, with a handle (or shank) that extends inwardly from the inner face of said plate and a head that extends transversely relative to this shank. There is no way that a catch, and particularly that all the catches, can be a dual catch (dual catches) with two shanks and two heads opposite one another.

A bracket is different from a catch. It involves a headless element that extends inwardly from the inner face of said plate. It preferably involves a flat plate.

Within the meaning of the present invention, the term “attach” or “attachment” is understood to be the mechanical attachments that are attached or detached manually or using a mechanical tool. The attached item is thus in a fixed position.

Within the meaning of the present invention, the term “fixing” is understood to be chemical fixings that generate irreversible molecular modifications, unless the bond is broken and the plate is rendered unusable.

Each of these two terms rules out the other.

The means for reversibly attaching said accessory are preferably only located on the inner face of said plate. They are not located on or against an edging of the plate, in order to allow a more compact accessory to be attached.

In a preferred version of the invention, said means for reversibly attaching said accessory are entirely integrally formed with said plate. Thus, it is possible for the plate to be molded directly; an additional part does not need to be provided to attach the accessory, against or partly inside the plate, such as, for example, one or more metal leaf springs; the plate is less expensive to manufacture than in the prior art.

Preferably, said plate comprises, in the lower part, two lateral inner catches, one of which is located to the right and the other one of which is located to the left of the hole of said plate, and said plate comprises, in the upper part, two lateral inner catches, one of which is located to the right and the other one of which is located to the left of the hole of said plate. Thus, the catches enable better positioning of the accessory when it is fixed by virtue of centering at the top and at the bottom.

Preferably, said plate comprises:
on the one hand, in the lower part, at least one, and preferably at least two, outer catch(es) respectively receiving said lower projecting cylindrical part; and
on the other hand, in the upper part, at least one, and preferably at least two outer catch(es) respectively receiving said upper projecting cylindrical part;

said outer catches being oriented in the same direction and being preferably oriented toward the top of said plate.

Said one or more bracket(s) each preferably exert a pressure, in a direction substantially parallel to the inner face of said plate, and more preferably downwardly, on one of said projecting cylindrical parts both below one of said adjacent inner catches and above one of said adjacent outer catches.

When there are two or more brackets, each bracket preferably exerts a pressure, in a direction substantially parallel to the inner face of said plate, and more preferably downwardly, on a projecting cylindrical part both below an adjacent inner catch and above an adjacent outer catch.

Furthermore, preferably, at least one vertical stop, and preferably at least two vertical stop(s) to the right and to the left of said hole, each vertically, and more preferably downwardly, block a projecting cylindrical part.

Said one or more vertical stop(s) each preferably comprise(s) a horizontal appendage. Said one or more vertical stop(s) is (or are) located transversely relative to the adjacent bracket.

Preferably, the width of at least one inner catch, and more preferably of each inner catch, is between 0.5 and 3.0 mm. One advantage that is thus provided is the compactness of the fixing of the accessory and thus of the plate. Furthermore, the plate is cheaper and is also lighter.

Said means for reversibly attaching said accessory are, preferably, disposed symmetrically relative to a central vertical plane. The hole of the plate can be centered on this central vertical plane, but the hole of the plate also can be offset to the left or to the right relative to this central vertical plane.

This symmetrical arrangement of the reversible attachment means particularly allows better lateral distribution of the forces when attaching the accessory and when operating the vehicle.

It is also possible for said plate to comprise elements for reversibly attaching an inner cover.

The glazing according to the invention can comprise the accessory or the accessories that is, or that are, attached using the plate.

Said optoelectronic accessory is, preferably, selected from a list comprising: a rain sensor, a luminosity sensor, a photographic sensor (device for capturing a fixed image in the visible range; analog or digital), an infrared sensor, a camera (device for capturing a moving image in the visible range; analog or digital).

Preferably, said glass pane is a curved laminated glass pane.

The present invention also relates to a part for fixing an optoelectronic accessory to the glazing according to the invention, said part comprising at least one plate that is intended to be fixed in facing an inner face of said glass pane of the glazing, said plate comprising, on the one hand, in the lower part, at least one, and preferably at least two, lower inner catch(es) for respectively receiving a lower projecting cylindrical part linked to said accessory, and, on the other hand, in the upper part, at least one, and preferably at least two, upper inner catch(es) for respectively receiving an upper projecting cylindrical part linked to said accessory, said inner catches being oriented in the same direction and being preferably oriented toward the top of said plate and said plate further comprising at least one, and preferably two, bracket(s) extending inwardly substantially at a right angle from the inner face of said plate and being able to press, in a direction substantially parallel to the inner face of said plate, and preferably downwardly, one of said projecting cylindrical parts against the adjacent inner catch.

The present invention thus allows very precise referencing of an accessory and highly reliable fixing thereof to the plate, and therefore to the glazing.

Thus, for a glazing, and from one glazing to the next from the same series, not only is the attachment of each accessory safe and secure, but it is also reliable over time.

Several embodiments are described hereafter, by way of non-limiting examples, with reference to the accompanying drawings, in which:

FIG. 1 is a partial perspective view of the top of a glazing according to the invention, mainly showing the inner face of a glass pane of this glazing, said glass pane comprising, on the inner face, a plate according to the invention for attaching a plurality of accessories, including an optoelectronic accessory, to this glass pane;

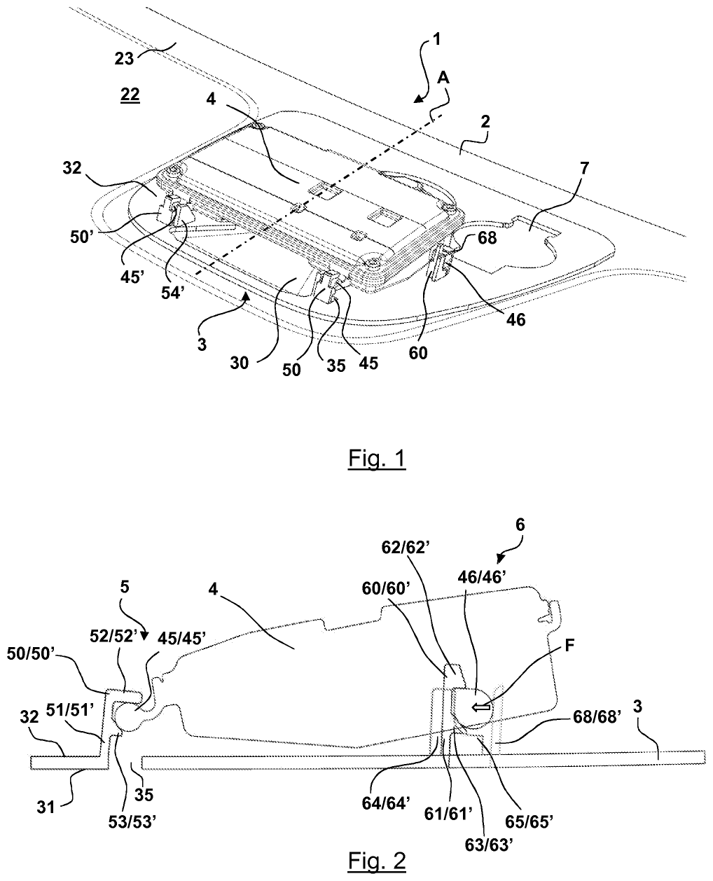

FIG. 2 is a schematic side view of the attachment of the optoelectronic accessory to the plate of FIG. 1;

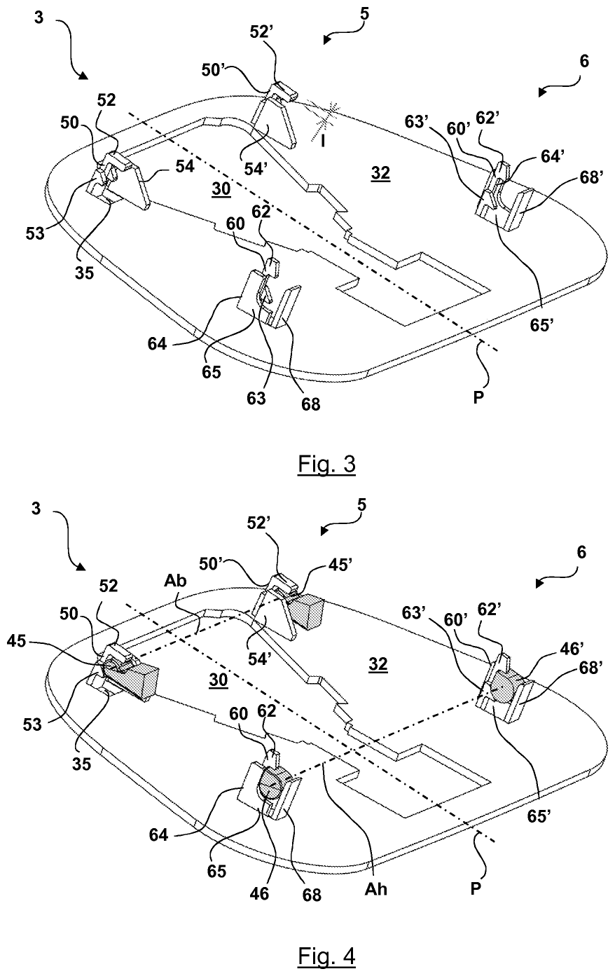

FIG. 3 is a perspective view of a variation of a plate according to the invention for attaching a single optoelectronic accessory; and

FIG. 4 is a partial perspective view of the plate of FIG. 3 showing the attachment of the accessory to the plate.

Throughout these figures, the proportions between the various elements are respected on each figure, but the background elements are generally not shown, in order to make them easier to read.

In FIG. 1, the top of the plate is at the top of the drawing and the bottom of the plate is at the bottom of the drawing; in FIG. 2, the top is to the right and the bottom is to the left, and in FIGS. 3 and 4, the bottom of the plate is at the top of the drawing and the top of the plate is at the bottom of the drawing.

The present invention relates to a glazing 1, and particularly to a glazing for a vehicle, such as that shown in FIG. 1 as a partial view from the interior of the vehicle, said glazing 1 comprising a glass pane 2 and at least one plate 3, fixed to the glass pane, for reversibly attaching an optoelectronic accessory 4 to the plate 3 and therefore to the glass pane 2.

The glazing 1 is intended to close an opening forming a mainly vertical separation between a space inside the vehicle and a space outside the vehicle. The glass pane 2 thus has an outer face 21 intended to be rotated toward the outer space, an inner face 22 intended to be rotated toward the inner space, as well as a peripheral edging.

Thus, when the concepts of “inner” and “outer” are referred to in the present document, it is always with reference to this consideration. Furthermore, when the concept of “vertical” and “horizontal” is referred to, it is also with reference to this consideration of the use of the glazing for a vehicle. Finally, the concepts of “left” and “right” also refer to this consideration, when the glass pane is viewed from the inside, as in FIG. 1, and relative to a vertical central axis A.

The glass pane can be monolithic, i.e. formed by a single sheet of material, or can be composite, i.e. formed by several sheets of material, between which at least one layer of adhesive material is inserted, in the case of composite/laminated glass panes. The one or more sheet(s) of material can be mineral(s), particularly glass, or can be organic(s), particularly plastic material.

In the case of a glazing for a vehicle, the glazing generally has, at least partially on its periphery, all around the edge of the inner face 22, a decorative strip 23. This decorative strip generally results from depositing enamel, which is implemented on the inner face of the glass pane when it is monolithic or on an interposed face of the glazing for laminated glass panes, but it also can result from partial and/or peripheral coloring of a sheet of material that is used, particularly a sheet made of organic material.

When the glass pane is made of organic material, it has been manufactured prior to the implementation of the invention by molding the constituent material of the glass pane in a molding device comprising a mold comprising at least one fixed mold part and one movable mold part, which can move relative to the fixed mold part, with said mold parts cooperating in the closed state of the mold, during the molding step, to form a molding cavity having a section that is the sectional shape of the glass pane. In many cases, the glass pane made of organic material is not flat but is curved.

When the glass pane is made of mineral material, it has been manufactured prior to the implementation of the invention by melting mineral material into a flat sheet, then by cutting this sheet and optionally curving and/or dip-coating this sheet.

When the glass pane is a composite glass pane, it has been manufactured using the well known technique for manufacturing laminated, and optionally curved, glass panes.

In FIG. 1, the glass pane 2 is a curved, laminated glass pane. In this case, it is a windshield of a motor vehicle.

The plate 3, which can be seen in FIGS. 1 and 2, comprises, on the one hand, an outer face 31 intended to be rotated toward the outer space and which is intended to be indirectly fixed to the inner face 22 of the glass pane facing this inner face of the glass pane and, on the other hand, an inner face 32 intended to be rotated toward the inner space, as well as a peripheral edging.

This plate 3 has a receptacle for receiving the accessory 4, which receptacle comprises means for reversibly attaching this accessory, as well as a hole 30. Part of the accessory 4 is intended to be positioned f acing this hole 30 so that the accessory is able to sense in front of the plate 3 and consequently in front of the glass pane 2.

The plate 3 shown in FIG. 1 further comprises at least one base 7 for reversibly attaching another accessory to the plate 3. The base 7 has a hole intended to be positioned facing this other accessory; the plate shown in FIGS. 3 and 4 is simpler since it allows a single optoelectronic accessory to be attached that is identical to that of FIGS. 1 and 2.

The outer face 31 of the plate that is shown in FIG. 2 is intended to be fixed to the inner face 22 of the glass pane by an adhesive material, not shown. This material can be a double-sided adhesive tape or a glue.

Of course, this adhesive material is disposed against the outer face of the plate so that the hole 30 that is used to operate the accessory 4 lacks any adhesive material.

The receptacle for the accessory is located in the inner face 32 of the plate. Thus, the inner face 32 comprises means 5, 6 for reversibly attaching the accessory 4.

By using the center of the accessory as a reference when it is attached to the plate, the means for reversibly attaching the accessory can be divided into:
lower means 5, for attaching the accessory at the bottom of the receptacle; and
upper means 6, for attaching the accessory at the top of the receptacle.

These means are the same throughout all the figures of the present document.

As shown in the figures, the lower means 5 comprise two lower inner catches 50, 50′ each respectively receiving a lower projecting cylindrical part 45, 45′, each of which is linked to said accessory 4, and the upper means 6 comprise two upper inner catches 60, 60′ each respectively receiving an upper projecting cylindrical part 46, 46′, each of which is linked to said accessory 4.

The lower projecting cylindrical parts 45, 45′ of the accessory 4 project relative to the body of the accessory, respectively to the right and to the left; the cylinder thereof has the same radius and the axes of the cylinder thereof coincide in the space along a lower cylindrical axis Ab.

The upper projecting cylindrical parts 46, 46′ of the accessory 4 project relative to the body of the accessory, respectively to the right and to the left; the cylinder thereof has the same radius and the axes of the cylinder thereof coincide in the space along a lower cylindrical axis Ah.

The upper and lower inner catches are preferably present in pairs, for each pair one is to the left and the other is to the right of the hole 30 in order to allow a symmetrical pressure to be exerted.

Even though it is not shown, it is possible for provision to be made for the lower means to comprise only one lower inner catch receiving a lower projecting cylindrical part linked to said accessory. In this case, the lower inner catch is preferably laterally centered relative to the accessory and the lower projecting cylindrical part is also then laterally centered relative to the accessory.

Even though it is not shown, it is also possible for provision to be made for the upper means to comprise only one upper inner catch receiving an upper projecting cylindrical part linked to said accessory. In this case, the upper inner catch is preferably laterally centered relative to the accessory and the upper projecting cylindrical part is also then laterally centered relative to the accessory.

All the inner catches 50, 50′, 60, 60′ are oriented in the same direction and in this case they are oriented toward the top of the plate 3, in order to implement retention that resists gravity.

The upper means 6 for attaching the accessory to the top of the receptacle further comprise two brackets 68, 68′ extending inwardly substantially at a right angle from the inner face 32 of the plate 3 and pressing, shown by the double arrow F, in a direction substantially parallel to the inner face 32 of the plate 3, each of the upper projecting cylindrical parts 46, 46′ against the adjacent upper inner catch 60, 60′. In this case, this pressure is substantially downward, in the direction of gravity in order to increase the available pressure force.

The lower means 5 for attaching the accessory to the bottom of the receptacle further comprise two outer catches 53, 53′ respectively receiving said lower projecting cylindrical part 45, 45′ by exerting an external pressure, and the upper means 6 for attaching the accessory to the top of the receptacle comprise two outer catches 63, 63′ respectively receiving said upper projecting cylindrical part 46, 46′ by exerting an external pressure.

All the outer catches 53, 53′, 63, 63′ are oriented in the same direction and in this case they are oriented toward the top of the plate 3, in order to implement retention that resists gravity.

The upper and lower outer catches are preferably present in pairs, for each pair one is to the left and the other is to the right of the hole 30 in order to allow a symmetrical pressure to be exerted.

Even though it is not shown, it is possible for provision to be made for the lower means to comprise only one lower outer catch receiving a lower projecting cylindrical part linked to said accessory. In this case, the lower outer catch is preferably laterally centered relative to the accessory and the lower projecting cylindrical part is also then laterally centered relative to the accessory.

Even though it is not shown, it is also possible for provision to be made for the upper means to comprise only one upper outer catch receiving an upper projecting cylindrical part linked to said accessory. In this case, the upper inner catch is preferably laterally centered relative to the accessory and the upper projecting cylindrical part is also then laterally centered relative to the accessory.

Each catch 50, 50′, 60, 60′, 53, 53′, 63, 63′ is in the form of a hammer and is formed by a shank that is linked to the inner face 32 of the plate and extends inwardly, as well as by a head extending transversely from an inner end of the shank.

As is more specifically shown in FIG. 2, the inner catches 50, 50′ are each formed by an upper shank 51, 51′ and a long head 52, 52′. The shanks 51, 51′ are called upper shanks since the height of each one, starting from the inner surface 32, is at least twice the diameter of the lower projecting cylindrical part 45, 45′, in this case approximately 2.2 times the diameter of the lower projecting cylindrical part 45, 45′. The heads 52, 52′ are called long heads since the length of each one, starting from the shank 51, 51′, is approximately the diameter of the lower projecting cylindrical part 45, 45′, in this case approximately 1 times the diameter of the lower projecting cylindrical part 45, 45′.

The outer catches 53, 53′ are each formed by a lower shank and by a short head. The shanks are called lower shanks since the height of each one, starting from the inner surface 32, is lower than the diameter of the lower projecting cylindrical part 45, 45′, in this case approximately 0.9 times the diameter of the lower projecting cylindrical part 45, 45′. The heads are called short heads since the length of each one, starting from the shank supporting them, is approximately the radius of the lower projecting cylindrical part 45, 45′, in this case approximately 1 times the radius of the lower projecting cylindrical part 45, 45′.

The figures also show that it is possible to duplicate an outer catch, in this case the lower outer catch 53, 53′ on each side, to the left and to the right of an inner catch, in this case the lower inner catch 50, 50′, in order to allow a balanced external counter-pressure to be exerted on each side of the inner pressure point. A lower outer catch 53, 53′, and even each lower outer catch 53, 53′, thus can be duplicated.

Even though it is not shown, it is possible to duplicate an inner catch, on each side, to the left and to the right of an outer catch, in order to allow a balanced internal counter-pressure to be exerted on each side of the outer pressure point.

As each catch comprises a head, it is preferable for a cut-out to be provided in line with this head in the thickness of the plate 3 in order to facilitate the removal of the molding of the corresponding catch.

However, by providing catch shanks that are close together, and even linked:
as is the case at the bottom: with a common shank for the inner catch 50 and the dual outer catch 53; as well as a common shank for the inner catch 50′ and the dual outer catch 53′;
as is the case at the top: with a common shank for the inner catch 60 and the outer catch 63; as well as a common shank for the inner catch 60′ and the outer catch 63′;

then the number of cut-outs is limited (in this case there are four, even if the only visible cut-out is that of reference sign 35) and the total surface area of cut-outs is limited.

This provides a favorable outcome compared to the prior art of allowing the surface area of the plate to be increased in face of the accessory and therefore allows the available surface area to be increased for fixing the plate to the glass pane.

FIG. 2 particularly shows that:
at the bottom: the two right-hand and left-hand projecting cylindrical parts 45, 45′ of the accessory are each simultaneously located immediately below and in contact with the adjacent lower inner catch 50, 50′ and immediately above and in contact with the adjacent lower outer catches 53, 53′;
at the top: the two right-hand and left-hand projecting cylindrical parts 46, 46′ of the accessory are each simultaneously located immediately below and in contact with the adjacent lower inner catch 60, 60′ and immediately above and in contact with the adjacent upper outer catch 63, 63′.

Thus, the brackets 68, 68′ each exert a direct pressure in a direction that is substantially parallel to the inner face 32 of said plate 3, shown by the double arrow F, in this case substantially downward, on each upper projecting cylindrical part 46, 46′, both below the adjacent upper inner catch 60, 60′ and above the adjacent upper outer catch 63, 63′.

Indirectly, by transmission through the body of the accessory, the brackets 68, 68′ each exert a pressure in a direction substantially parallel to the inner face 32 of said plate 3, shown by the double arrow F, in this case substantially downward, on each lower projecting cylindrical part 45, 45′, both below the adjacent lower inner catch 50, 50′ and above the adjacent lower outer catch 53, 53′.

The lower means 5 for attaching the accessory to the bottom of the receptacle further comprise two lateral guides 54, 54′, more particularly shown in FIGS. 3 and 4, blocking the lower projecting cylindrical part 45, 45′, respectively to prevent it from moving further to the left and further to the right.

The upper means 6 for attaching the accessory at the top of the receptacle further comprise two vertical and upper stops 64, 64′, one to the right and the other to the left of said hole 30, each vertically, and in this case specifically downwardly, blocking an upper projecting cylindrical part 46, 46′.

These upper vertical stops 64, 64 each comprise a horizontal appendage 65, 65′ blocking the upper projecting cylindrical part 46, 46′, respectively to prevent it from moving further to the right and further to the left.

The width l of each of the inner catches 50, 50′, 60, 60′ is between 0.5 and 3.0 mm:
which in this case is 2.0 mm for the lower inner catches 50, 50′; and
which in this case is 1.0 mm for the upper inner catches 60, 60′.

As is particularly shown in FIGS. 3 and 4, said lower 5 and upper 6 means for reversibly attaching the accessory 4 are symmetrically disposed relative to a central vertical plane P.

The accessory is attached in the following order:
i—the accessory 4 is moved toward the plate 3 previously fixed to the inner face of the glass pane 2;
ii—the lower projecting cylindrical parts 45, 45′ are introduced together between the lower inner catch 50, 50′ and the lower outer catch 53, 53′, respectively; these lower projecting cylindrical parts 45, 45′ can rotate on themselves while remaining in contact, both below the lower inner catch 50, 50′ and above the lower outer catch 53, 53′;
iii—the accessory is rotated about the axis Ab until the upper projecting cylindrical parts 46, 46′ reach the upper inner catches 60, 60′; this rotation is laterally guided by the lateral guides 54, 54′;
iv—a pressure (manual or by automaton) is exerted on the top of the accessory 4 and toward the outside in order to introduce the upper projecting cylindrical parts 46, 46′ together, between the upper inner catch 60, 60′ and the upper outer catch 63, 63′, respectively, while separating the brackets 68, 68′ toward the top; this introduction is guided by the horizontal appendages 65, 65′;
v—the brackets 68, 68′ remain slightly deformed toward the top and thus each apply a downward force on the upper projecting cylindrical parts 46, 46′, so as to permanently retain them against the upper vertical stops 64, 64.

In order to facilitate the passage of the upper projecting cylindrical parts 46, 46′ between, on the one hand, the upper catches 60, 60′, 63, 63′ and the brackets 68, 68′, the brackets in this case are manufactured as shanks with a rectangular section and the same length as the upper projecting cylindrical parts 46, 46′. The height of each bracket, taken from the inner face 32, is greater than the overall height starting from the same reference point for the upper outer catches 63, 63′, while being below the overall height starting from the same reference point for the upper inner catches 60, 60′. The brackets are approximately 1 millimeter thick.

The flexibility of the brackets 68, 68′ to allow this passage of the upper projecting cylindrical parts 46, 46′ must be greater than the flexibility of the upper inner catches 60, 60′. In other words, the pressure provided by the upper catches 60, 60′, 63, 63′ for the upper projecting cylindrical parts 46, 46′ is relatively rigid, whereas the pressure of the brackets 68, 68′ on the upper projecting cylindrical parts 46, 46′ is relatively flexible. It involves a flat pressure.

All these pressures are properly centered on both sides, to the left and to the right, of a central vertical axis of the accessory so that during use none of them tends to move the accessory in its receptacle.

Detachment is carried out by performing the same operations in reverse. It is easy to implement since not much force is required for the step iv of deforming the brackets 68, 68′. It is easy for the attachment and detachment to be repeated as many times as desired, for example, to check the accessory or to change the accessory if necessary, without ever causing any damage to the means for reversibly attaching the accessory to the plate.

The lower 5 and upper 6 means for reversibly attaching the accessory 4 are entirely integrally formed with the plate 3; the plate 3, with all these means, is manufactured in a single direct molding operation; no additional part or element needs to be provided against the plate or partly inside the plate, such as, for example, one or more metal leaf springs.

The material for the plate 3 can be, for example: polyamide (and particularly PA 66), ABS or polyethylene.

The whole part thus formed by the plate 3 can be manufactured by molding, for example, in a single operation and with very high precision.

Even though it is not shown, the plate 3 also allows reversible attachment of an inner cover, which obscures the plate and the accessory 4 from the interior of the vehicle.

The reversibly attachable accessories can be selected from a list comprising: a rain sensor, a luminosity sensor, a photographic sensor (device for capturing a fixed image in the visible range; analogue or digital), an infrared sensor, a camera (device for capturing a moving image in the visible range; analogue or digital). It particularly can involve accessories that must be positioned in the vehicle with extremely high precision.

The reversible attachment implemented with the invention is extremely precise. The gap between the accessory and the plate is approximately one tenth of a millimeter.

The single part forming the plate 3 is fixed to the inner face 22 of the glass pane using an automatic, semi-automatic or manual method.

1. A glazing for a vehicle comprising a glass pane and at least one plate for reversibly attaching at least one optoelectronic accessory to said glass pane, said at least one plate having a hole facing said at least one optoelectronic accessory, an outer face that is fixed facing an inner face of said glass pane and an inner face oriented on an opposite side regarding said outer face of said at least one plate, said inner face of said at least one plate comprising an attachment system configured to reversibly attach said at least one optoelectronic accessory, wherein said at least one plate comprises, in a lower part, at least one lower inner catch receiving a lower projecting cylindrical part linked to said at least one optoelectronic accessory, and, in an upper part, at least one upper inner catch receiving an upper projecting cylindrical part linked to said at least one optoelectronic accessory, said lower and upper inner catches being oriented in a same direction and said at least one plate further comprising at least one bracket extending inwardly substantially at a right angle from the inner face of said at least one plate and pressing, in a direction substantially parallel to the inner face of said at least one plate one of said projecting cylindrical parts against the adjacent inner catch.

2. The glazing as claimed in claim 1, wherein said attachment system configured to reversibly attach said at least one optoelectronic accessory is entirely integrally formed with said at least one plate.

3. The glazing as claimed in claim 1, wherein said at least one plate comprises, in the lower part, two lateral inner catches located to the right and to the left of the hole of said at least one plate, and wherein said at least one plate comprises, in the upper part, two lateral inner catches located to the right and to the left of the hole of said plate.

4. The glazing as claimed in claim 1, wherein said at least one plate comprises, in the lower part, at least one outer catch receiving said lower projecting cylindrical part, and, in the upper part, at least one outer catch receiving said upper projecting cylindrical part, said outer catches being oriented in a same direction.

5. The glazing as claimed in claim 4, wherein said at least one bracket exerts a pressure, in a direction substantially parallel to the inner face of said at least one plate, on one of said projecting cylindrical parts both below one of said adjacent inner catches and above one of said adjacent outer catches.

6. The glazing as claimed in claim 1, wherein at least one vertical stop vertically blocks a projecting cylindrical part.

7. The glazing as claimed in claim 6, wherein said at least one vertical stop comprises a horizontal appendage.

8. The glazing as claimed in claim 1, wherein a width of at least one inner catch is between 0.5 and 3.0 mm.

9. The glazing as claimed in claim 1, wherein said attachment system configured to reversibly attach said accessory is symmetrically disposed relative to a central vertical plane.

10. The glazing as claimed in claim 1, comprising at least one optoelectronic accessory selected from a list comprising: a rain sensor, a luminosity sensor, a photographic sensor, an infrared sensor, a camera, a display screen support.

11. A part for fixing an optoelectronic accessory to the glazing as claimed in claim 1, said part comprising at least one plate that is intended to be fixed facing an inner face of said glass pane, said at least one plate comprising in the lower part, at least one lower inner catch for receiving a lower projecting cylindrical part linked to said at least one optoelectronic accessory, and in the upper part, at least one upper inner catch for receiving an upper projecting cylindrical part linked to said at least one optoelectronic accessory, said lower and upper inner catches being oriented in the same direction and said at least one plate further comprising at least one bracket extending inwardly substantially at a right angle from the inner face of said at least one plate and being able to press, in a direction substantially parallel to the inner face of said at least one plate, one of said projecting cylindrical parts against the adjacent inner catch.

12. The glazing as claimed in claim 1, wherein in the lower part, the at least one lower inner catch includes at least two lower inner catches, and, in the upper part, the at least one upper inner catch includes at least two upper inner catches.

13. The glazing as claimed in claim 1, wherein said lower and upper inner catches are oriented toward the top of said plate.

14. The glazing as claimed in claim 1, wherein said at least one plate further comprises at least two brackets extending inwardly substantially at a right angle from the inner face of said at least one plate.

15. The glazing as claimed in claim 1, said at least one bracket presses downwardly one of said projecting cylindrical parts against the adjacent inner catch.

16. The glazing as claimed in claim 4, wherein, in the lower part, said at least one outer catch includes at least two outer catches, and, in the upper part, said at least one outer catch includes at least two outer catches.

17. The glazing as claimed in claim 4, wherein said outer catches are oriented toward the top of said plate.

18. The glazing as claimed in claim 5, wherein said at least one bracket exerts a pressure downwardly.

19. The glazing as claimed in claim 6, wherein the at least one vertical stop includes at least two vertical stops positioned respectively to the right and to the left of said hole.

20. The glazing as claimed in claim 8, wherein the width of each inner catch is between 0.5 and 3.0 mm.
